(19) United States
(12) Patent Application Publication
(10) Pub. No.: US 2015/0229131 A1
(43) Pub. Date: Aug. 13, 2015

(54) GRID TIE SOLAR INVERTER SYSTEM WITH STORAGE

(71) Applicant: Nextronex, Inc., Holland, OH (US)

(72) Inventor: Peter F. Gerhardinger, Maumee, OH (US)

(21) Appl. No.: 14/600,092

(22) Filed: Jan. 20, 2015

Related U.S. Application Data
(60) Provisional application No. 61/939,300, filed on Feb. 13, 2014.

(51) Int. Cl. H02J 3/38; H02M 7/42; H02J 7/00; H02J 7/35

(52) U.S. Cl. CPC H02J 3/385; H02J 7/35; H02M 7/42; H02J 7/0013

(57) ABSTRACT

A grid tie solar inverter system includes a DC solar array generating a DC voltage and a DC current. A DC bus is connected to the DC solar array to receive the DC current from the DC solar array. A battery bank is connected to the DC bus to transfer the DC current of the DC solar array to charge a plurality of batteries of the battery bank. At least one inverter is connected to the DC bus thereby connecting the DC bus to an AC grid. The inverter is operated either to transfer stored energy of the battery bank to the AC grid or to transfer AC power from the AC grid to the battery bank to charge the battery bank. A controller in communication with the battery bank monitors DC solar array and battery bank operating conditions.

### CROSS REFERENCE TO RELATED APPLICATIONS

The present application claims priority to U.S. Provisional Application Ser. No. 61/939,300 filed Feb. 13, 2014. The foregoing Application is incorporated by reference herein in its entirety.

### FIELD

The invention pertains to solar inverters and, more particularly, to a grid tie solar inverter system having battery power storage with inverters operated to control current flow in opposing system load directions.

### BACKGROUND

Integrating storage into utility scale solar arrays has received significant attention in the last several years as battery technology and cost have evolved. Particularly in areas with high electricity costs and reliable solar insolation (such as in the Caribbean), battery storage is seen to provide multiple benefits: 1) to buffer short term energy dips from partly cloudy conditions (deep discharge, short cycle times) defined as “smoothing”; 2) to shift or extend the operating window of solar generated electricity either into the evening, or over a 24 hour cycle (shallow discharge, long cycle times), defined as “shifting”; 3) to provide both frequency and voltage regulation; 4) to allow voltage peak “grid support” during peak voltage conditions; and 5) to help mitigate against grid power outages.

In many applications, the amount of energy storage (kWh) is a small percentage of the size of a DC solar array. Solar inverters are sized to match the predicted peak output of an array, and one of the key functions of a solar inverter typically is managing peak power tracking (MPPT) of a DC solar array to maximize energy harvesting. In a typical grid tie application solar inverters convert the DC from the DC solar array into AC suitable to feed into the AC electrical grid. Therefore the DC voltage from the DC solar array will vary with temperature and insolation, while the AC voltage must be regulated to match the AC grid voltage.

Conceptually, using batteries with photovoltaic systems is straightforward, but there are challenges such as:
1. A battery cannot be directly connected to the DC solar array without back feed protection. Charging currents, voltage levels, and nighttime back feed into the solar panels are factors that must be managed.
2. Solar Inverters cannot pull from a battery bank using MPPT algorithms. Since a battery curve is much different than a solar panel IV curve, the inverter(s) tend to oscillate because they essentially see a constant voltage device.
3. If the array utilizes a central inverter, and the battery capacity is much less than the DC solar array capacity, the central inverter may be very inefficient when discharging the battery.

Current practice therefore is to separate the battery inverter process from the solar inverter process such that these are parallel systems with battery charge management and AC conversion. This practice, however, adds cost and complexity.

It would be desirable to develop a grid tie solar inverter system with storage capabilities.

### SUMMARY

Concordant and congruous with the present invention, a grid tie solar inverter system with storage capabilities has surprisingly been discovered.

According to several embodiments, a grid tie solar inverter system, includes a DC solar array generating a DC voltage and a DC current. A DC bus is connected to the DC solar array to receive the DC voltage and the DC current from the DC solar array. A battery bank is connected to the DC bus to transfer the DC voltage and the DC current of the DC solar array to charge a plurality of batteries of the battery bank. At least one inverter is connected to the DC bus and thereby connects the DC bus to an AC grid. The at least one inverter is operated to transfer stored energy of the battery bank to the AC grid, to transfer AC power from the AC grid to the battery bank to charge the battery bank, or to transfer DC voltage as AC power from the solar array to the AC grid.

According to other embodiments, a grid tie solar inverter system includes a DC solar array generating a DC voltage and a DC current. A DC bus is connected to the DC solar array to receive the DC voltage and the DC current from the DC solar array. A battery bank is connected to the DC bus to transfer the DC voltage and the DC current of the DC solar array to charge a plurality of batteries of the battery bank. A controller such as a programmable logic controller (PLC) in communication with the battery bank acts to monitor operating conditions of the DC solar array and the battery bank. Multiple inverters are connected to the DC bus and connect the DC bus to an AC power source. The multiple inverters are each in communication with and are independently controlled by the controller to selectively operate to transfer stored energy of the battery bank to the AC power source, to transfer AC power from the AC power source to the battery bank to charge the battery bank, or to transfer DC voltage as AC power from the solar array to the AC power source.

According to further embodiments, a method for operating a grid tie solar inverter system includes: generating a DC voltage and a DC current by a DC solar array; connecting a DC bus to the DC solar array to receive the DC voltage and the DC current from the DC solar array during operation of the DC solar array; connecting a battery bank to the DC bus; transferring the DC voltage and the DC current of the DC solar array from the DC bus to charge a plurality of batteries of the battery bank; directly connecting at least one inverter to the DC bus to connect the DC bus to an AC grid; and controlling operation of the at least one inverter to selectively operate either to transfer stored energy of the battery bank to the AC grid or to transfer AC power from the AC grid to the battery bank to charge the battery bank.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a diagram of a grid tie solar inverter system with storage capabilities according to an embodiment of the invention;

FIG. 2 is a graph comparing battery voltage versus photovoltaic operating voltage over an exemplary ambient temperature operating window;

FIG. 3 is a diagram of a grid tie solar inverter system with storage capabilities according to another embodiment of the invention, showing a battery charging configuration;

FIG. 4 is a diagram of the grid tie solar inverter system of FIG. 3, showing a battery discharging configuration;

FIG. 5 is a diagram of the grid tie solar inverter system of FIG. 3, showing independent operation of the inverters;

FIG. 6 is a graph showing operation of the grid tie solar inverter system of FIG. 1 over a period of both charging and discharging operations; and

FIG. 7 is a diagram of a grid tie solar inverter system modified to include alternate AC sources to provide supplemental AC current.

### DETAILED DESCRIPTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

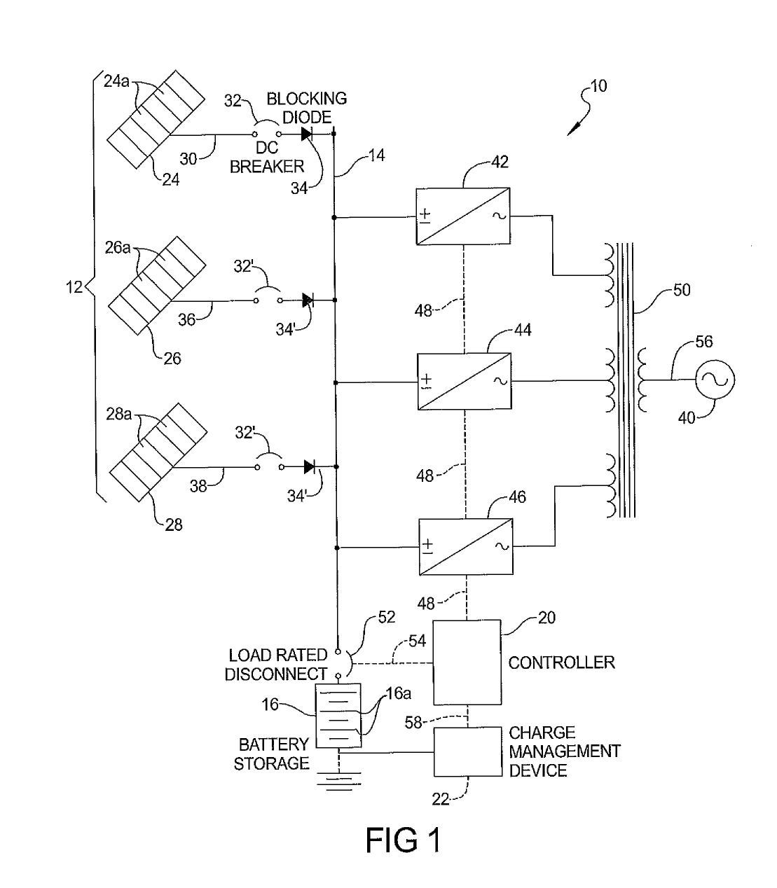

Referring to FIG. 1, according to one embodiment of the invention, a grid tie solar inverter system 10 with storage capabilities includes a photovoltaic or DC solar array 12 generating DC voltage and current that is distributed to a DC bus 14. A battery bank 16 can be aligned with the DC bus 14 that uses the output DC voltage and current of the DC solar array 12 to charge individual batteries 16a of the battery bank 16. A controller 20, such as a programmable logic controller (PLC) is in communication with the battery bank 16, directs operation of the components of grid tie solar inverter system 10, and monitors operating conditions of the DC solar array 12, the battery bank 16, and other components of the grid tie solar inverter system 10.

The grid tie solar inverter system 10 also includes a charge management device 22, which monitors the charging/discharging state of the batteries of the battery bank 16 and can shift between a charging state, pulling DC current from the DC solar array 12 via the DC bus 14 to charge the batteries of the battery bank 16, and a discharging state of the battery bank 16. According to several aspects, the charge management device 22 can be a separate computer supported device independent of the controller 20 and can be in electrical communication with the controller 20 such as via an Ethernet connection. According to further aspects, the charge management device 22 is incorporated into the controller 20.

The DC solar array 12 can include multiple array segments each having a plurality of photovoltaic panels, which may include for example a first array segment 24 having a plurality of photovoltaic panels 24a, a second array segment 26 having a plurality of photovoltaic panels 26a, and a third array segment 28 having a plurality of photovoltaic panels 28a. Each of the array segments normally includes an equal quantity of the photovoltaic panels, however the quantity of photovoltaic panels is not limiting. In one exemplary embodiment, a typical array segment can include 18 parallel configured groups of twenty two (22) photovoltaic panels arranged in series, each panel generating 250 Watts of electrical power. This exemplary configuration of photovoltaic panels generates approximately 99 kW at 660 VDC at 150 Amps.

The photovoltaic panels 24a of the first array segment 24 are connected to the DC bus 14 using a DC transfer bus 30 to transfer the DC voltage and the DC current output of the photovoltaic panels 24a to the DC bus 14. A DC breaker 32 sized for the load (for example 200 A) is provided in the DC transfer bus 30, and a blocking diode 34 is also provided in the DC transfer bus 30 between the DC breaker 32 and the DC bus 14. Blocking diodes such as blocking diode 34 are used to prevent the battery bank 16 from discharging through the photovoltaic panels of the DC solar array 12 at night, or when the DC solar array 12 is not operational. The second array segment 26 is similarly connected to the DC bus 14 using a DC transfer bus 36, and the third array segment 28 is connected to the DC bus 14 using a DC transfer bus 38. Each of the DC transfer bus 36 and the DC transfer bus 38 include similar components as the DC transfer bus 30, which are therefore identified with a prime symbol, including a DC breaker 32′ and a blocking diode 34′.

During sunny conditions, the battery bank 16 can be directly charged with DC current from the DC solar array 12, and DC current can also be exported to an AC power source such as an AC grid 40, managed by multiple solar inverters individually connected to the DC bus 14. These can include inverters such as a first inverter 42, a second inverter 44, and a third inverter 46. Less than three, or more than three inverters can also be used, as the quantity and size of the inverters is in part determined by the size of the DC solar array 12, such that the quantity and size of the inverters is not limiting to the disclosure. The first inverter 42, the second inverter 44, and the third inverter 46 are connected to and are operationally controlled by the controller 20 via control lines 48. Each of the inverters is connected to a transformer 50 which is connected to the AC grid 40 by a common AC bus 56.

The charge management device 22 and the controller 20 read a battery charge status during both charging and discharging operations, current into and out of the DC combined bus 14 as well as DC voltage, the available energy from the DC solar array 12, and a desired or maximum DC bus voltage stored in the controller 20, and control a charge state of the battery bank 16 to maintain the battery charge, as well as operation of the first inverter 42, the second inverter 44, and the third inverter 46. Set points of the first inverter 42, the second inverter 44, and the third inverter 46 can be individually or collectively varied by the controller 20 to ensure that a desired percentage or fraction of an instantaneous DC solar array 12 current (power) is divided between the AC output to the AC grid 40, and the DC output to the battery bank 16.

Once the battery bank 16 is charged, or partially charged and available for use, DC power from the battery bank 16 can be transferred via the DC bus 14 to system loads, and/or to the AC grid 40. The DC bus 14 is sized proportional to a capacity of the battery bank 16, therefore, all or less than all of the inverters 42, 44, 46 can be transferred to the DC bus 14 at a given time. The DC bus 14 also includes a load rated disconnect 52 to selectively isolate the battery bank 16 from the DC solar array 12 if a DC voltage measured on the DC bus 14 exceeds a predetermined maximum rated DC voltage of the battery bank 16. The open or closed status of the load rated disconnect 52 is communicated to the controller 20 via a communication line 54, and the open or closed position of the load rated disconnect 52 can be changed by a signal from the controller 20. It should also be apparent that AC power available on the AC grid 40 can be transferred via the first inverter 42, the second inverter 44, and the third inverter 46 to the DC bus 14 to carry loads off the DC bus 14, and from the DC bus 14 to the battery bank 16 for use in charging the batteries of the battery bank 16. In further embodiments, the load rated disconnect 52 can be removed from the DC bus 14 and can be provided as one or more appropriately rated devices located within individual sections of the battery bank 16 itself.

Based on either user demand, or other signal, a selected one or more of the first, second, and third inverters 42, 44, 46 may be transferred to the DC bus 14, and placed into a “constant current” operating mode by the controller 20. As long as the DC voltage from the battery bank 16 is within a range required by the inverters 42, 44, 46 to feed the AC grid 40, the outputs of one or all of the first inverter 42, the second inverter 44, and the third inverter 46 can be sent to the AC grid 40 via the common AC bus 56. Any one or more of the first, second, and third inverters 42, 44, 46 can be operational at a given time to transfer power to the AC grid 40. For a given “bank” of inverters, one or more can be processing the available solar energy from the DC bus 14 under MPPT control, while one or more can be processing the available energy from the battery bank 16 via the DC bus 14 under constant current control. To place the battery bank 16 on the DC bus 14, the first, second, and third inverters 42, 44, 46 first match the DC voltage of the DC bus 14 to the DC voltage of the battery bank 16 prior to dosing the contactor(s) of the inverters.

Operation of the grid tie solar inverter system 10 can be follows.

### Battery Off-Line:

During conditions when the battery bank 16 is off-line, normal harvesting of the power of the solar array 12 can be performed via the first, second, and third inverters 42, 44, 46 using MPPT control to transfer power to system loads, and/or to the AC grid 40. When the battery bank 16 is off-line at night, the solar array 12 is off.

### Battery On-Line:

SUNLIGHT AVAILABLE: The battery bank 16 is charging, AC power can be exported to the AC grid 40. The inverters manage the MPPT of the solar array 12. The battery bank 16 can be used to firm up the DC voltage of the DC bus 14.
NIGHT-TIME: One or more selected ones of the inverters are positioned in a constant output mode; and the battery bank 16 is discharged at a selected discharge rate to manage night-time system loads.

During a typical diurnal cycle, the grid tie solar inverter system 10 operates as follows. Prior to dawn, the battery bank 16 is disconnected from the DC bus 14 by the controller 20 directing the contactor of the load rated disconnect 52 to open. As the sun rises, DC voltage on the DC bus 14 rises, and the controller 20 signals the first, second, and third inverters 42, 44, 46 to come on line and begin to export power to the AC grid 40. When sufficient solar power is available the DC bus 14 voltage will exceed the battery bank 16 terminal voltage. At this time, one or more of the first, second, and third inverters 42, 44, 46 are directed by the controller 20 to momentarily clamp the bus voltage at the open-circuit battery bank 16 voltage. By doing so, the inverters match the DC bus voltage to the battery bank terminal voltage. The controller 20 then directs the load rated disconnect 52 to close, connecting the battery bank 16 to the DC bus 14.

Based on a battery bank state of charge measured by the charge management device 22, and solar availability, one or all of the first, second, and third inverters 42, 44, 46 manage a battery bank charging rate by adjusting the DC bus 14 voltage. When the battery charge of the battery bank 16 approaches a full charge, the first, second, and third inverters 42, 44, 46 regulate the DC bus 14 bus voltage to track the MPPT of the DC solar array 12, while also limiting voltage excursions the could overcharge the battery bank 16 batteries,

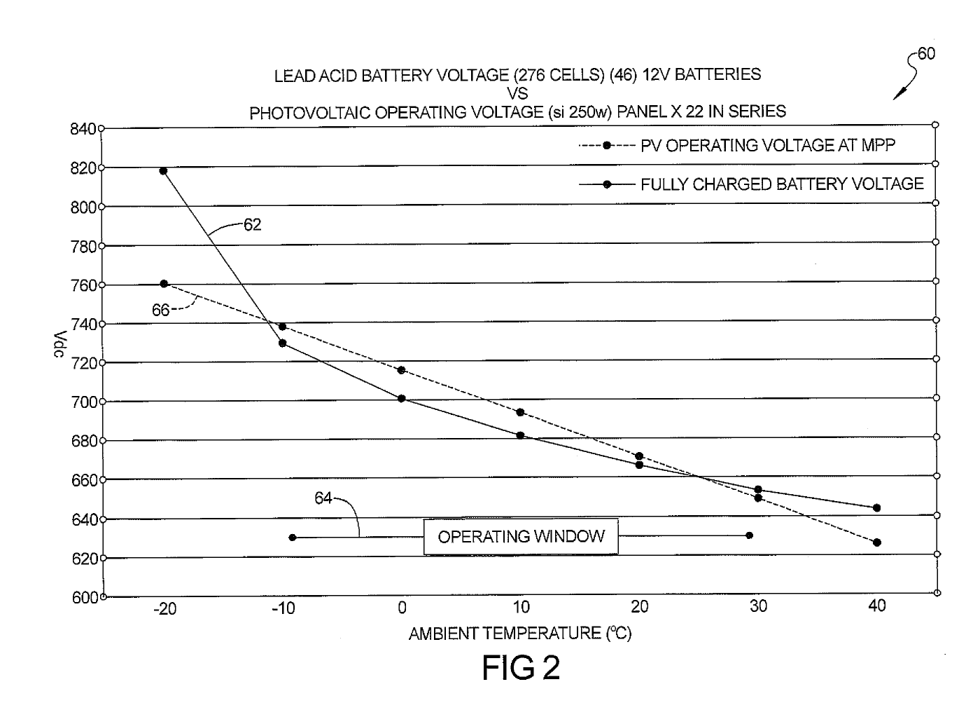

When cloud transients occur, the battery bank 16 voltage is used to “firm-up” the DC voltage of the DC bus 14 to minimize power fluctuations. This condition is enhanced by the grid tie solar inverter system 10 because as will be better described in reference to FIG. 2 the DC voltages between the battery bank 16 and the DC solar array 12 are closely matched. As the sun later wanes during the late afternoon/evening, the battery bank 16 increases its contribution to the DC bus 14, or controller 20 can disconnect the battery bank 16 by opening the load rated disconnect 52 to allow a natural decay of the solar array voltage on the DC bus 14. If the charge management device 22 determines the battery bank 16 state of charge is nearly depleted, the inverters are shut down.

Following sunset, controller 20 positions the first, second, and third inverters 42, 44, 46 in standby mode, and there is no load on the DC bus 14. The load rated disconnect 52 can be closed to connect the battery bank 16 to the DC bus 14, and the controller 20 can operate a selected quantity of the first, second, or third inverters 42, 44, 46 in a battery charging or reverse mode to supply AC power from the AC grid 40 to the load. The quantity of first, second, and third inverters 42, 44, 46 operated is proportional to the discharge rate (kW/Hr) of the battery bank 16. When the battery bank 16 is discharged or the load is satisfied, the controller 20 shuts down the first, second, and third inverters 42, 44, 46, removing the load from the DC bus 14. The battery bank 16 is then disconnected by opening the load rated disconnect 52, and is ready to repeat the cycle during a following day.

If the battery bank 16 is out of service, the battery bank 16 is disconnected from the DC bus 14 by opening the load rated disconnect device 52. As the sun rises or as solar energy is available, the first, second, or third inverters 42, 44, 46 are brought on line in MPPT mode. Thereafter, the first, second, or third inverters 42, 44, 46 are added or shed by the controller 20 based on instantaneous power available to the solar array 12, and are commonly sequentially shut down with approaching sunset. At or shortly after sunset, the last of the operating first, second, or third inverters 42, 44, 46 is shut down.

Referring to FIG. 2, a graph 60 depicts a fully charged battery voltage range 62 over a system temperature operating range 64 defined as an anticipated system ambient temperature ranging between -10 degrees Centigrade and 30 degrees Centigrade for lead-acid batteries. The battery voltage range 62 closely matches a voltage output range 66 of a typical solar panel photovoltaic panel over the same ambient temperature range. Graph 60 identifies that a closely matched voltage operating range permits a system of the present disclosure to connect a battery bank to the DC bus being fed power from a solar array over the anticipated ambient conditions expected.

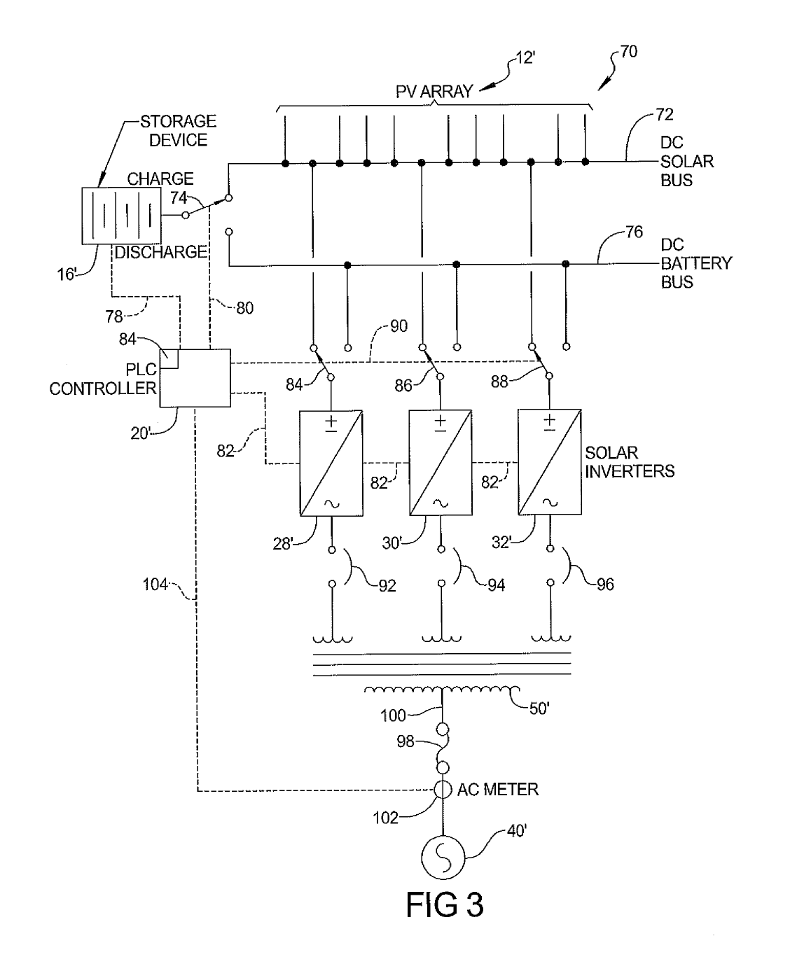

Referring to FIG. 3, according to a further embodiment, a grid tie solar inverter system 70 with storage capabilities includes components that are similar to grid tie solar inverter system 10 and are therefore identified with a prime symbol. Grid tie solar inverter system 70 includes a photovoltaic or DC solar array 12′ generating DC voltage that is distributed to a DC solar bus 72. A battery bank 16′ can be aligned with the DC solar bus 72 that uses the output DC voltage of the solar array 12′ to charge the individual batteries of the battery bank 16′. The battery bank 16′ can be connected to the DC solar bus 72 using a transfer switch 74. The transfer switch 74 toggles the battery bank 16′ between a charging state, pulling DC current from the solar array 12′ via the DC solar bus 72, and a discharging state, sending current to a selected inverter or group of inverters such as first, second, and third inverters 28′, 30′, 32′ via a DC battery bus 76. A controller 20′ is in communication with the battery bank 16′ and acts to monitor operating conditions of the solar array 12′, the battery bank 16′, and other components of the grid tie solar inverter system 70.

Controller 20′ is in communication with each of the battery bank 16′ via a communication line 78, the transfer switch 74 via a communication line 80, and with the first, second, and third inverters 28′, 30′, 32′ via a communication line 82. According to several embodiments, a charge management device 84, which functions similar to charge management device 22, is functionally included in the controller 20′. To provide for individual operation of any one or all of the first, second, and third inverters 28′, 30′, 32′ a first inverter transfer switch 84 is provided to selectively connect the first inverter 28′ to the DC solar bus 72 or to the DC battery bus 76. Similarly, a second inverter transfer switch 86 is provided to selectively connect the second inverter 30′ to the DC solar bus 72 or to the DC battery bus 76, and a third inverter transfer switch 88 is provided to selectively connect the third inverter 30′ to the DC solar bus 72 or to the DC battery bus 76. The number of inverter transfer switches used is dependent on the quantity of inverters. Controller 20′ is in communication with the first, second, and third inverter transfer switches 84, 86, 88 via a communication line 90, and thereby directs connectivity of one or all of the first, second, and third inverters 28′, 30′, 32′.

A first inverter load rated disconnect 92 is connected between the first inverter 28′ and the transformer 50′. Similarly, a second inverter load rated disconnect 94 is connected between the second inverter 30′ and the transformer 50′ and a third inverter load rated disconnect 96 is connected between the third inverter 32′ and the transformer 50′. An overload fuse 98 is positioned in an AC line 100 between the transformer 50′ and the AC grid 40′. An AC meter 102 is further positioned between the overload fuse 98 and the AC grid 40′ to provide indication of AC current flow in AC line 100. The controller 20′ is further in communication with the AC meter 102 via a communication line 104.

As shown in FIG. 3, the battery bank 16′ can be charged by DC current from the DC solar bus 72 with the transfer switch 74 positioned as shown. There is no load on the DC battery bus 76 at this time. DC current from operation of the DC solar array 12′ imposing current in the DC solar bus 72 can also be drawn off to the AC grid 40′ by selective positioning of the first, second, and third inverter transfer switches 84, 86, 88 as shown to align the first, second, and third inverters 28′, 30′, 32′ with the AC grid 40′. DC voltage of the DC solar bus 72 is in part controlled within the desired range of the batteries of the battery bank 16′ during a charging operation by connection of the first, second, and third inverters 28′, 30′, 32′.

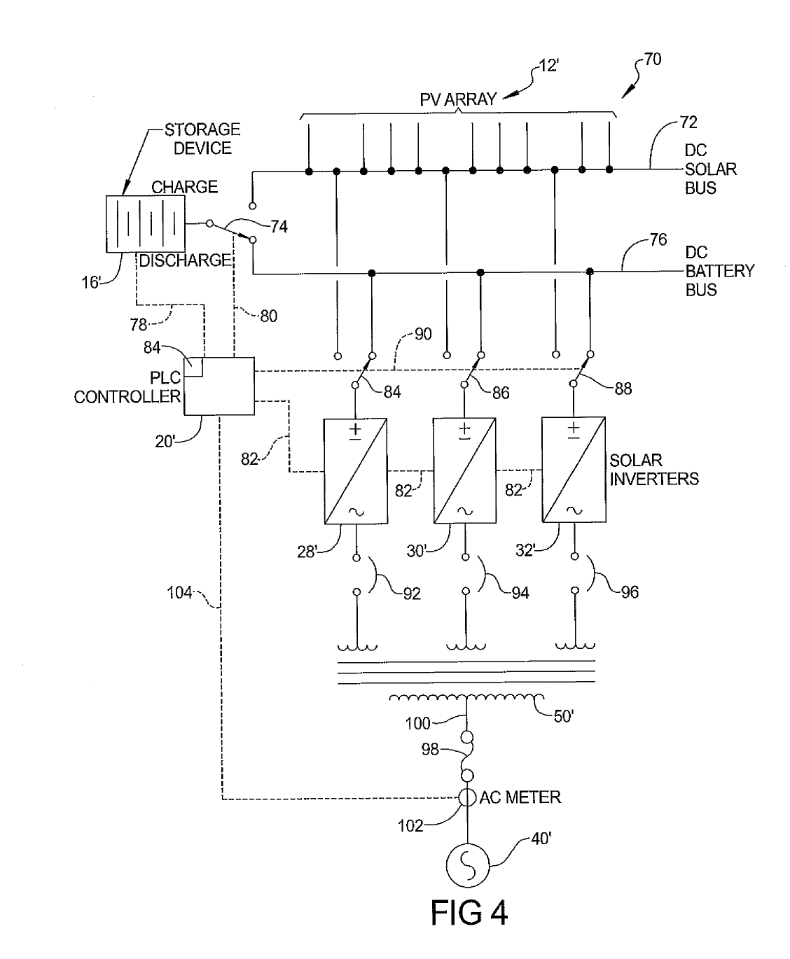

Referring to FIG. 4 and again to FIG. 3, when the battery bank 16′ is fully or at least partially charged, DC power can be withdrawn from the battery bank 16′ by connecting the battery bank 16′ to the DC battery bus 76. This is accomplished by one or more signals from the controller 20′ directed via the communication line 90 to change position of the first, second, and third inverter transfer switches 84, 86, 88 to connect the DC battery bus 76 to each of the first, second, and third inverters 28′, 30′, 32′. DC battery power is then transferred via the first, second, and third inverters 28′, 30′, 32′ to the AC grid 40′.

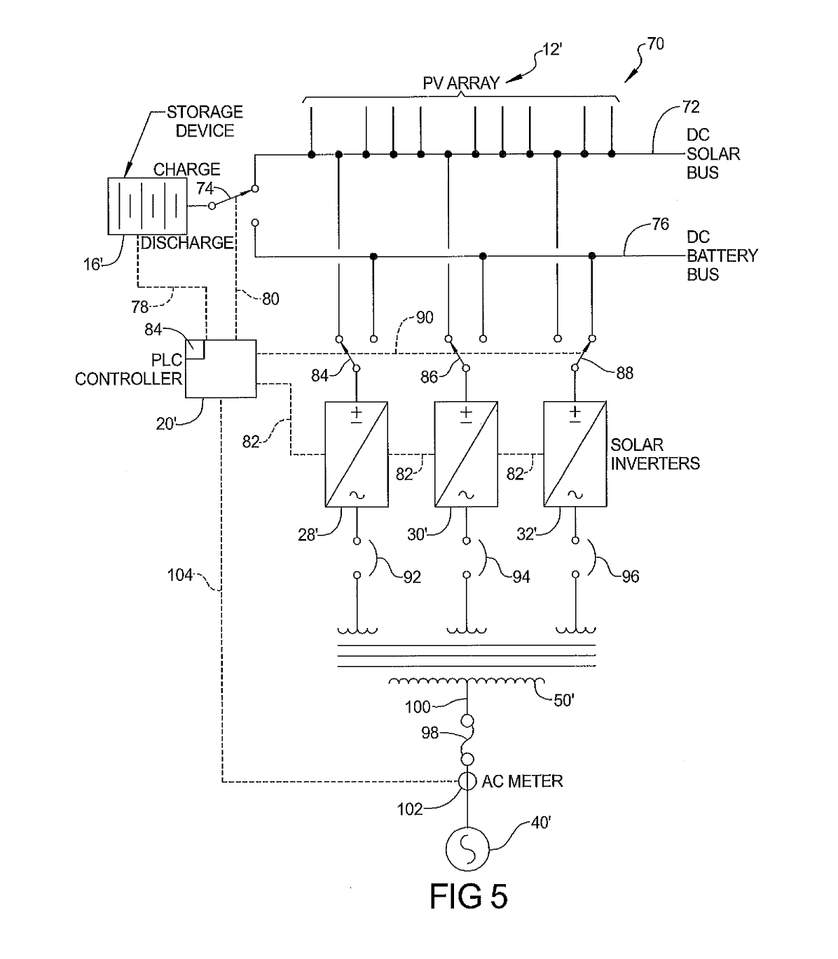

Referring to FIG. 5 and again to FIGS. 3-4, different operating combinations of the first, second, and third inverters 28′, 30′, 32′ can be used, for example to handle temporary voltage swings, such as during cloud transients. For example, the first and second inverters 28′, 30′ can be aligned with the DC solar bus 72 to permit both charging of the battery bank 16′ and current flow to the AC grid 40′. The third inverter transfer switch 88 is positioned to align the third inverter 32′ with the AC grid, however there is no load on the DC battery bus 76 at this time. When the battery bank 16′ is at least partially charged, during a cloud transient which temporarily reduces the DC voltage of the DC solar bus 72, controller 20′ signals the transfer switch 74 to reposition from contact with the DC solar bus 72 to contact with the DC battery bus 76. At this time, there is no load on the DC solar bus 72, and DC current from the battery bank 16′ is available via the third inverter 32′ to flow to the AC grid 40′ or other load of the DC battery bus 76. Any combination of the first, second, and third inverters 28′, 30′, 32′ (or other inverters if present) can be connected to either the DC solar bus 72 or the DC battery bus 76 as determined by the controller 20′ to allow selected inverters to receive DC current from either the DC solar bus 72 (in MPPT mode), or the DC battery bus 76 (in constant current mode).

The inverters of the grid tie solar inverter system 10 can also be connected as described above with respect to the grid tie solar inverter system 70 to allow individual or combined usage of any one or all of the inverters of the grid tie solar inverter system 10.

In addition, depending on the rating of the DC battery bus 76 and the battery bank 16′, not all of the inverters need to be provided with a bus transfer switch. For example, a 1 MW DC solar array may utilize 5 inverters (not shown), but if the battery capacity is only 250 kW (for example), only two of the five inverters may include a bus transfer switch, such as the first and second inverter transfer switches 84, 86 previously described, which helps reduce system cost and complexity.

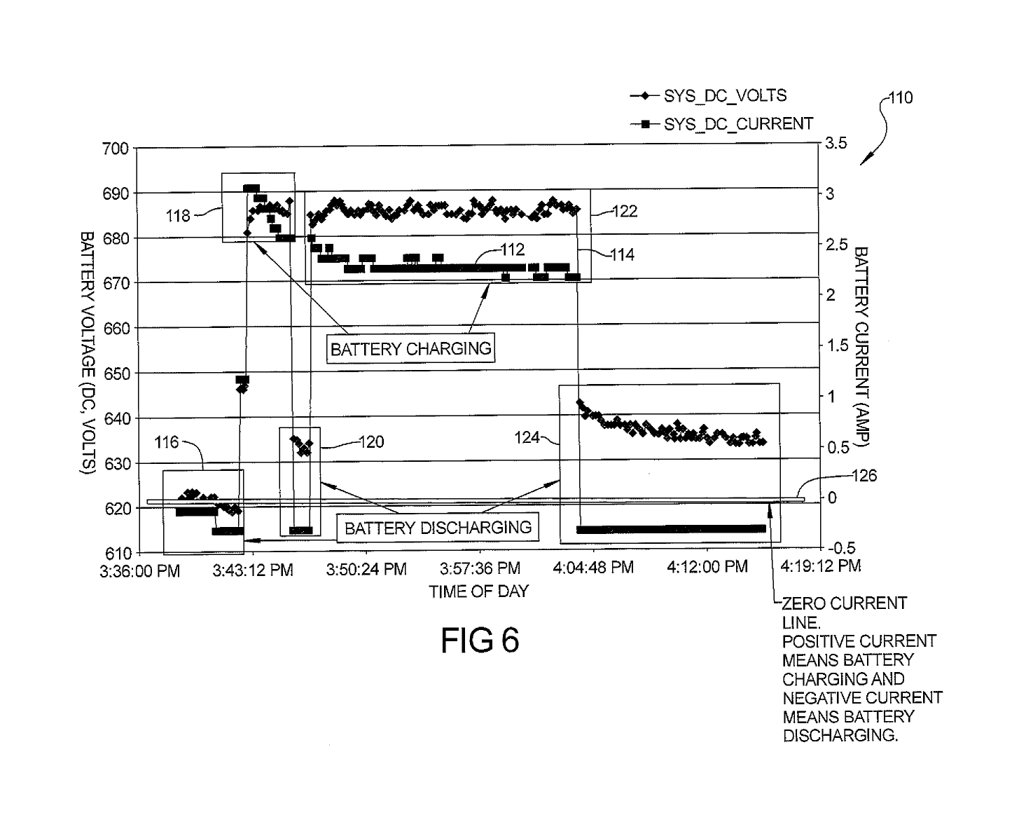

Referring to FIG. 6 and again to FIG. 1, a graph 110 presents exemplary operating conditions for battery charging and battery discharging events occurring during a one hour operating window during a battery bank test. A system DC current line 112 and a system DC voltage line 114 are separated during periods of charging and discharging. The initial battery voltage was approximately 622 VDC and the batteries were discharging, as indicated during a first discharging period 116. A DC power supply was used to take the DC bus voltage higher than the battery bank voltage. The system DC current line 112 and the system DC voltage line 114 overlap during times of transition, for example between the first discharging period 116 and a first charging period 118. As soon as the DC bus voltage was taken higher than the battery bank voltage the battery bank began the first charging period 118.

Simulated periods of operation during clear daytime conditions and during cloudy conditions are further presented as a second battery discharging period 120, a lengthy second battery charging period 122, and a lengthy third battery discharging period 124. A zero current line 126 occurring at a DC voltage of approximately 622 VDC identifies by a positive battery current above the zero current line 126 when battery charging is occurring, and by a negative battery current below the zero current line 126 when battery discharging is occurring. As the DC bus voltage dropped below the battery voltage the battery bank discharged. DC bus voltage level remained substantially at the battery DC voltage level as the battery bank slowly discharged.

The systems of the present disclosure tying a battery bank, a solar array, and one or more inverters on a common bus, with an interconnect to an AC grid to provide a single control point and manage two control objectives. The system manages the MPPT function of the DC solar array in a quasi-MPPT mode which can vary depending on a battery state-of-charge, an available solar generated power, and a load demand. In quasi-MPPT mode the system also manages and regulates the charge/discharge states of the battery bank. The inverters are thereby directed to an appropriate current draw that best satisfies instantaneous demands.

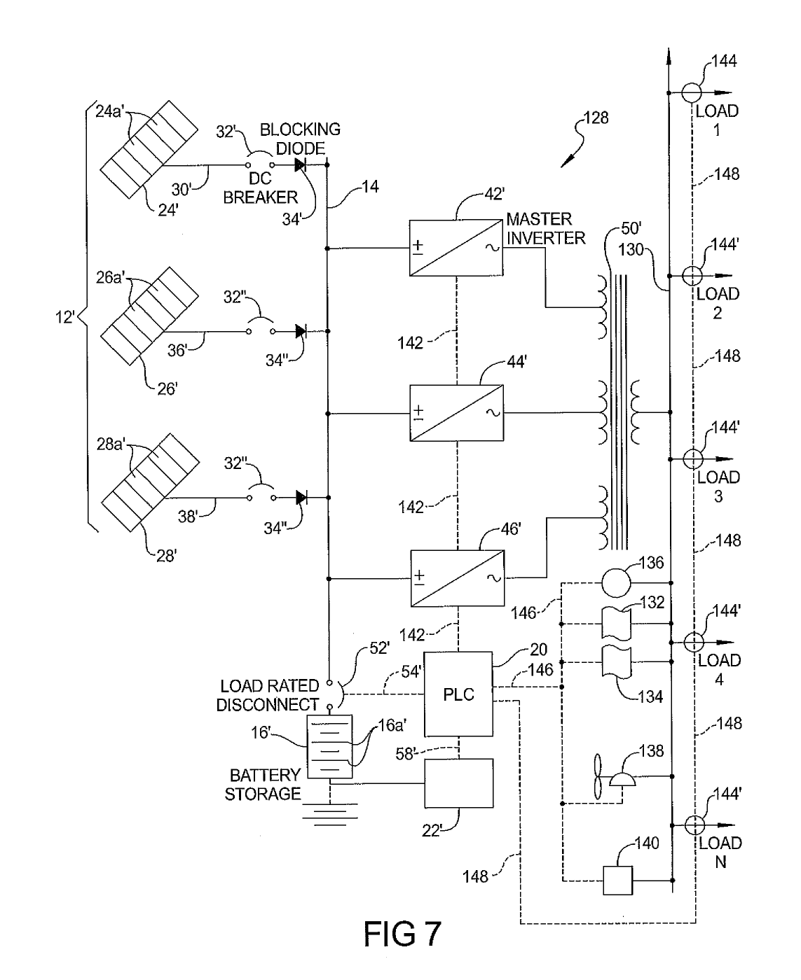

Referring to FIG. 7, according to further embodiments, in a micro-grid system 128, in situations where a standard AC grid may not be available or may be unstable or unreliable for supplying AC power, an alternate AC power source 130 can be provided which can be fed from the output of one or more alternate AC power generation devices, for example generators such as a first generator 132 and a second generator 134. The alternate AC power generation devices can also include a diesel generator 136, a wind powered generator 138, and a fuel cell/inverter 140. The generators may be provided as gas-fired micro-turbines. The fuel source for the generators is not limiting, such that other fossil fuel fired generators can also be used including diesel generators. The alternate AC power generation devices such as the first and second generators 132, 134 provide an additional backup source of AC power.

Inverters, such as the first, second, and third inverters 42′, 44′, 46′ of the present disclosure, via control lines 142 can also function as the AC frequency reference that the alternate AC power generation devices such as the first and second generators 132, 134 can synchronize to as they are brought on or off line and thereby provide seamless switching into and out of a generator operating mode. Multiple loads, as load 1, load 2, load 3, load 4, through a load “n” are connected to the bus of alternate AC power source 130. Each of the loads is connected to a meter, including a first meter 144, with second and subsequent meters identified as meters 144′. The controller 20′ is in communication with each of the alternate AC power generation devices using a control line 146. The controller 20′ is also in communication with each of the meters 144, 144′ via a communication line 148 such that the controller 20′ can monitor the current of each of the loads.

According to several aspects, one of the inverters, for example first inverter 42′ can be designated for continuous (24 hrs/day) operation as a “master” inverter thereby providing a continuously available 60 Hz reference signal for synchronizing any of the generators or other ones of the alternate AC power generation devices. The use of a master inverter provides a common reference signal for seamless startup of any of the alternate AC power generation devices. This inverter mode is in volts per Hz and is the mode that a variable frequency device (VFD) inverter normally operates in.

Operation of micro-grid system 128 can be as follows with respect to the exemplary first and second generators 132, 134. Initially, the first and second generators 132, 134 are de-energized. When solar energy is available, power for system loads can be sourced from the DC solar array 12′ as the least cost option. When the DC solar array 12′ cannot provide all of the necessary system load requirements, or if solar energy is not available, system loads can be carried or supplemented by the energy stored in the battery bank 16′. When the DC solar array 12′ and the battery bank 16′ are insufficient to provide for all system loads, or if solar energy is not available and the battery bank 16′ is energy depleted, one or more of the first, second, or third inverters 42′, 44′, 46′ can be operated to provide AC power which the alternate AC power source 130 can synchronize to. For example, when any of the first, second, or third inverters 42′, 44′, 46′ are operated, at least one of the first or second generators 132, 134 are energized by a signal from the controller 20′ via communication line 146.

Because one of the first, second, or third inverters 42′, 44′, 46′, such as the first inverter 42′ discussed above, is designated as the master inverter, providing a continuously available 60 Hz reference signal for synchronizing any of the generators, micro-grid system 128 provides for seamless conversion to operation of any one or all of the alternate AC power generation devices such as the first and second generators 132, 134. Because the fuel source for operation of the alternate AC power generation devices such as the first and second generators 132, 134 may be more expensive for power generation than power generated using the DC solar array 12′ or the battery bank 16′, the controller 20′ continuously monitors the availability of power from both the DC solar array and the battery bank 16′, such that operation of the alternate AC power generation devices is the last selected option.

From the foregoing description, one ordinarily skilled in the art can easily ascertain the essential characteristics of this invention and, without departing from the spirit and scope thereof, can make various changes and modifications to the invention to adapt it to various usages and conditions.

I claim:

1. A grid tie solar inverter system, comprising:
a DC solar array generating a DC voltage and a DC current;
a DC bus connected to the DC solar array to receive the DC voltage and the DC current from the DC solar array;
a battery bank connected to the DC bus to transfer the DC voltage and the DC current of the DC solar array to charge a plurality of batteries of the battery bank; and
at least one inverter connected to the DC bus connecting the DC bus to an AC grid, the at least one inverter selectively operated either to transfer stored energy of the battery bank to the AC grid or to transfer AC power from the AC grid to the battery bank to charge the battery bank.

2. The grid tie solar inverter system of claim 1, further comprising a charge management device functionally monitoring a charging/discharging state of the plurality of batteries of the battery bank operable to shift between a charging state pulling DC current from the DC solar array via the DC bus to charge the batteries of the battery bank, and a discharging state of the battery bank.

3. The grid tie solar inverter system of claim 2, further comprising a controller in communication with the battery bank acting to monitor operating conditions of the DC solar array and the battery bank, wherein the charge management device is independent of the controller and in electrical communication with the controller.

4. The grid tie solar inverter system of claim 2, further comprising a controller in communication with the battery bank acting to monitor operating conditions of the DC solar array and the battery bank, wherein the charge management device is incorporated into the controller.

5. The grid tie solar inverter system of claim 1, wherein the DC solar array includes a plurality of array segments each including a plurality of photovoltaic panels, the photovoltaic panels of each array segment connected to the DC bus using one of a plurality of DC transfer busses to transfer a DC voltage and a DC current output of the photovoltaic panels to the DC bus.

6. The grid tie solar inverter system of claim 5, further comprising:
a DC breaker provided in each of the plurality of DC transfer busses, and
a blocking diode positioned in each of the plurality of DC transfer busses between the DC breaker and the DC bus, the blocking diode preventing the battery bank from discharging through the photovoltaic panels of the DC solar array at night.

7. The grid tie solar inverter system of claim 1, further comprising a controller in communication with the battery bank acting to monitor operating conditions of the DC solar array and the battery bank, wherein a set point of the at least one inverter is varied by the controller to ensure that a desired percentage or fraction of an instantaneous DC solar array current is divided between an AC output to the AC grid, and a DC output to the battery bank.

8. The grid tie solar inverter system of claim 1, wherein the at least one inverter comprises multiple inverters, and wherein the DC bus is sized proportional to a capacity of the battery bank, such that all or less than all of the multiple inverters are connected to the DC bus at a given time.

9. The grid tie solar inverter system of claim 1, further comprising a controller in communication with the battery bank acting to monitor operating conditions of the DC solar array and the battery bank, and
wherein the DC bus further includes a load rated disconnect operated by a signal from the controller to selectively isolate the battery bank from the DC solar array if a DC voltage of the DC bus exceeds a predetermined maximum DC voltage of the battery bank, an open or closed status of the load rated disconnect being communicated to the controller via a controller communication line, and an open or closed position of the load rated disconnect being changed by a signal from the controller.

10. The grid tie solar inverter system of claim 1, wherein the DC bus is divided into a DC solar bus and a DC battery bus, and including a transfer switch operating to selectively connect the battery bank to either the DC solar bus to charge a plurality of batteries of the battery bank using the DC solar array, or to the DC battery bus to permit discharge of the plurality of batteries to the AC grid.

11. A grid tie solar inverter system, comprising:
a DC solar array generating a DC voltage and a DC current;
a DC bus connected to the DC solar array to receive the DC voltage and the DC current from the DC solar array;
a battery bank connected to the DC bus to transfer the DC voltage and the DC current of the DC solar array to charge a plurality of batteries of the battery bank;
a controller in communication with the battery bank acting to monitor operating conditions of the DC solar array and the battery bank; and
multiple inverters connected to the DC bus and connecting the DC bus to an AC power source, the multiple inverters each in communication with and independently controlled by the controller to selectively operate either to transfer stored energy of the battery bank to the AC power source or to transfer AC power from the AC power source to the battery bank to charge the battery bank.

12. The grid tie solar inverter system of claim 11, further comprising a load rated disconnect in the DC bus selectively operable between an open and a closed state to selectively isolate the battery bank from the DC solar array.

13. The grid tie solar inverter system of claim 12, wherein the load rated disconnect in the open state acts to isolate the battery bank from the DC solar array, the load rated disconnect operated by a signal from the controller to selectively isolate the battery bank from the DC solar array if a DC voltage of the DC bus exceeds a predetermined maximum DC voltage of the battery bank.

14. The grid tie solar inverter system of claim 12, wherein an open or closed status of the load rated disconnect is communicated to the controller via a controller communication line, and an open or closed state of the load rated disconnect being changed by a signal from the controller.

15. The grid tie solar inverter system of claim 11, further comprising:
a plurality of DC transfer busses connecting the DC solar array to the DC bus;
a DC breaker provided in each of the plurality of DC transfer busses, and
a blocking diode positioned in each of the plurality of DC transfer busses between the DC breaker and the DC bus, the blocking diode preventing the battery bank from discharging through the DC solar array.

16. The grid tie solar inverter system of claim 11, further comprising:
at least one generator defining the AC power source, the at least one generator being normally de-energized and operable using a signal from the controller; and
one of the multiple inverters being designated as a master inverter being continuously operational by a signal from the controller to function as an AC frequency reference that the at least one generator synchronizes to, thereby providing seamless switching into and out of a generator operating mode.

17. A method for operating a grid tie solar inverter system, comprising:
generating a DC voltage and a DC current by a DC solar array;
connecting a DC bus to the DC solar array to receive the DC voltage and the DC current from the DC solar array during operation of the DC solar array;
connecting a battery bank to the DC bus;
transferring the DC voltage and the DC current of the DC solar array from the DC bus to charge a plurality of batteries of the battery bank;
directly connecting at least one inverter to the DC bus to connect the DC bus to an AC grid; and
controlling operation of the at least one inverter to selectively operate either to transfer stored energy of the battery bank to the AC grid or to transfer AC power from the AC grid to the battery bank to charge the battery bank.

18. The method of claim 17, further comprising placing a controller in communication with the battery bank and the at least one inverter acting to monitor operating conditions of the DC solar array and the battery bank.

19. The method of claim 18, further comprising controlling operation of the at least one inverter using the controller to manage peak power tracking of the solar array.

20. The method of claim 18, further comprising controlling operation of the at least one inverter using the controller to apply the DC voltage of the battery bank to firm up a DC voltage of the DC bus.

21. The method of claim 18, further comprising:
when solar power is available at the DC solar array determining that a DC bus voltage exceeds a battery bank terminal voltage;
via the controller directing momentarily clamping the DC bus voltage at the battery bank terminal voltage; and
via the controller directing a load rated disconnect to close, connecting the battery bank to the DC bus.
